(19) United States
(12) Patent Application Publication
(10) Pub. No.: US 2023/0401539 A1
(43) Pub. Date: Dec. 14, 2023

(54) MEETING LOCATION RECOMMENDATION SYSTEM

(71) Applicant: Microsoft Technology Licensing, LLC, Redmond, WA (US)

(72) Inventors: Satish CHANDRA, Bothell, WA (US); Manish RAJANGAM, Bellevue, WA (US); Jiaming WANG, Bellevue, WA (US)

(21) Appl. No.: 17/836,857

(22) Filed: Jun. 9, 2022

(51) Int. Cl. G06Q 10/10

(52) U.S. Cl. CPC G06Q 10/1095

(57) ABSTRACT

The systems and methods provide recommendations for scheduling meetings. The methods and systems identify different subgroups of meeting attendees for a meeting and provide recommendations for the meeting locations and meeting times for each subgroup. The methods and systems also identify a meeting context for the meeting and use the meeting context to identify the subgroups of meeting attendees, the recommended meeting locations for each subgroup, or the recommended meeting times for each subgroup.

### BACKGROUND

Hybrid working environments are becoming more popular in enterprise environments. While employees have explored the new world of working remotely, there is now a craving for occasional in person meetings or meetups as well. Employees are taking into account traffic conditions, commute distances, and/or weather conditions in deciding whether to work from home or work in the office. When employees show up to work at the office, the employees may not be physically located in the same building as other team members. For example, an organization may be spread out across different buildings within the same city or different countries.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes obtaining meeting attendees for a meeting from meeting context information. The method includes identifying features for the meeting attendees. The method includes identifying a meeting context for the meeting. The method includes placing the meeting attendees into groups based on the features and the meeting context, wherein each group has a subset of the meeting attendees. The method includes determining a meeting location and a meeting time for each group. The method includes providing a recommendation with the meeting location and the meeting time for each group.

Some implementations relate to a device. The device includes one or more processors; memory in electronic communication with the one or more processors; and instructions stored in the memory, the instructions executable by the one or more processors to: obtain meeting attendees for a meeting from meeting context information; identify features for the meeting attendees; identify a meeting context for the meeting; place the meeting attendees into groups based on the features and the meeting context, wherein each group has a subset of the meeting attendees; determine a meeting location and a meeting time for each group; and provide a recommendation with the meeting location and the meeting time for each group.

Some implementations relate to a method. The method includes obtaining a meeting context of a meeting from meeting context information for the meeting. The method includes obtaining meeting attendees for the meeting from the meeting context. The method includes providing a recommendation for scheduling a plurality of asynchronous meetings for the meeting attendees prior to a start time of the meeting based on the meeting context of the meeting. The method includes providing a meeting time and a meeting location for each asynchronous meeting of the plurality of asynchronous meetings, wherein each asynchronous meeting is scheduled for an individual meeting attendee.

Some implementations relate to a device. The device includes one or more processors; memory in electronic communication with the one or more processors; and instructions stored in the memory, the instructions executable by the one or more processors to: obtain a meeting context of a meeting from meeting context information for the meeting; obtain meeting attendees for the meeting from the meeting context; provide a recommendation for scheduling a plurality of asynchronous meetings for the meeting attendees prior to a start time of the meeting based on the meeting context of the meeting; and provide a meeting time and a meeting location for each asynchronous meeting of the plurality of asynchronous meetings, wherein each asynchronous meeting is scheduled for an individual meeting attendee.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for providing recommendations for scheduling meetings in accordance with implementations of the present disclosure.

FIG. 2 illustrates an example graphical user interface of a meeting invitation with a recommendation for a plurality of groups for a meeting in accordance with implementations of the present disclosure.

FIG. 3 illustrates an example graphical user interface of a meeting invitation with a recommendation for an asynchronous meeting in accordance with implementations of the present disclosure.

FIG. 4 illustrates an example method for providing a recommendation for a meeting in accordance with implementations of the present disclosure.

FIG. 5 illustrates an example method for providing a recommendation for a meeting in accordance with implementations of the present disclosure.

FIG. 6 illustrates components that may be included within a computer system.

### DETAILED DESCRIPTION

This disclosure generally relates to providing recommendations for scheduling meetings. Hybrid working environments are becoming more normal in enterprise environments where employees work remotely part of the time and in person at the office part of the time. Employees are taking into account traffic conditions, commute distances, and/or weather conditions in deciding whether to work from home or work in the office. When employees show up to work at the office, the employees may not be physically located in the same building as other team members. For example, an organization may be spread out across different buildings within the same city and/or different countries.

Typically, when a meeting is scheduled, a conference room or a central location is booked, and the meeting attendees show up in person at the same physical location for the meeting. However, during Covid, virtual meetings became how meetings were conducted and the meeting attendees attended the meeting virtually. While employees have explored the new world of working remotely, there is now a craving for occasional in person meetings or meetups as well. Therefore, employees are putting extra efforts to plan physical meetings at a mutually agreed upon time in locations that are convenient.

The present disclosure relates to methods and systems for providing recommendations for scheduling meetings in-person or virtually. The methods and systems may also provide recommendations for hybrid meetings, a meeting that occurs both in-person and virtually. As such, a portion of the meeting attendees meet in person for the meeting while a portion of the meeting attendees meet virtually for the meeting.

The methods and systems identify different subgroups of meeting attendees for a meeting that may be more likely to meet in person for the meeting. The methods and systems provide recommendations for the meeting locations for each subgroup and connects the different meeting locations with a virtual meeting link. The subgroups may have in-person interactions with different individuals while having the flexibility of choosing a meeting location to attend the meeting that is convenient for the meeting attendee (e.g., in the building that the meeting attendee chooses to visit or in a coffee shop close to the meeting attendee residential address). The virtual meeting link provides a connection so that the meeting attendees at the different physical meeting locations may communicate together. As such, the meeting attendees of the different subgroups have the in-person interaction for the meeting while maintaining a flexibility of being close to their residential address and/or interacting with other groups in real time using the virtual meeting link.

The methods and systems may recommend different physical locations for the subgroups to meet. For example, a team is scheduling a meeting and the groups of the team members may have offices in multiple buildings. The methods and systems may identify the smaller groups of the team members located in the same building and may provide a recommendation for dividing the team members into smaller groups for the meeting along with recommended meeting locations for each of the buildings that the groups are located. As such, the team members may meet in person for the meeting while being able to stay within or near their building for the meeting enabling more human interactions with the in-person meetings without a loss of productivity caused by geographical distances traveled for the meeting.

The methods and systems may identify when a meeting has both global and local characteristics (e.g., the meeting attendees are located in different geographical locations with clusters of individuals in a local area) and may provide a recommendation to provide local in-person meeting options for different subgroups of the meeting attendees while connecting the different subgroups of meeting attendees together using the virtual meeting link. For example, one subgroup for a meeting is in India, another subgroup for the meeting is in Europe, and another subgroup for the meeting is in the United States. The methods and systems may schedule a meeting (e.g., a glocal meeting) for the different subgroups for the meeting so that the subgroup in India meets at a different time than the subgroup in the United States and the subgroups in the United States and Europe meet at the same time. A glocal meeting is a meeting that may meet at different times and has both global aspects and local aspects for the meeting. The glocal meeting may be a meeting that is between meeting attendees that are distributed in different geographic locations (e.g., different countries, different states, or different cities) but may also have subgroups of the meeting attendees in a same local geographic location (e.g., the same city or town). The different subgroups may meet at different times convenient for each geographical region and may communicate with the other subgroups using a common virtual meeting channel (e.g., the chat feature of the common virtual meeting channel) associated with the glocal meeting. As such, the methods and systems may schedule the meeting with the different subgroups having a local physical meeting option in each country for the subgroups.

The methods and systems may also identify a context of the meeting (e.g., goals, purposes, needs, objectives, and/or content of the meeting) and use the context of the meeting to identify the subgroups of the meetings and whether the subgroups for the meeting may meet at different times. The meeting context helps identify meetings where smaller groups of meeting attendees may be beneficial to discuss subsections of the document. The meeting context also helps identify meetings that may benefit from being conducted in-person or virtually. For example, if the purpose of the meeting is a brainstorming meeting, an in-person meeting may be more beneficial. If the content of the meeting is informational, a virtual meeting may be more beneficial.

The meetings can happen at the same time or may happen at different times for the smaller groups. When a particular meeting may occur at different points in time, different subgroups may meet at a time that may be different from when other subgroups are meeting. The meeting context and geographical locations of the meeting attendees may be used to determine whether the subgroups may be scheduled at different times. For example, if the attachment is a document that has multiple subsections and different teams are responsible for different subsections of the document, different subgroup meetings may be scheduled to handle the subsections of the document at different times. Yet, the different subgroups may stay abreast of the developments in other subgroups through use of a meeting chat feature of the common virtual meeting channel.

Coordinating a convenient time for all subgroups to meet during working hours becomes difficult when the subgroups are in different countries. As such, the methods and systems may use the context of the meeting to determine whether the different subgroups may meet at various times for the meeting. The methods and systems create a single overall meeting while scheduling the different subgroups at separate times for the overall meeting.

In some implementations, the methods and systems use machine learning models to identify features (i.e., a feature set) for the meeting and/or a meeting context for the meeting. The features of the meeting and/or the meeting context may be obtained from a meeting invitation opened for scheduling the meeting. In some implementations, users (e.g., individuals of an organization) may have to explicitly opt into data collection and/or the users can opt out of data collection. The features may include the number of attendees, office location of the attendees, business hours of the attendees, and/or a residential address of the attendees. The methods and systems use the features and/or the meeting context to determine the different subgroups for the meetings and place the meeting attendees into the different subgroups.

In some implementations, the methods and systems may use the meeting to identify that the meeting attendees may benefit from asynchronous meetings prior to the meeting occurring. The methods and systems may recommend available times and/locations for the asynchronous meetings so that each meeting attendee may have time blocked for the asynchronous meeting. For example, the meeting context identifies the meeting is for discussing a document and the asynchronous meetings may be scheduled for the meeting attendees at an available time and an available location to review the document offline prior to the meeting.

One technical advantage of the methods and systems of the present disclosure is inferring a context of a meeting and using the context of the meeting to aid in determining a location and/or a time for the meeting. Another technical advantage of the methods and systems of the present disclosure is to divide meeting attendees into subgroups based on different features of the meeting attendees and/or the meeting context. The methods and systems automatically identify meeting locations and/or meeting times for the different subgroups and may schedule the meeting for the different subgroups at the identified meeting locations and/or meeting times. Another technical advantage of the methods and systems of the present disclosure is distributing the load of virtual meetings by scheduling global meetings across the working hours of the individual subgroups instead of having all the meetings occur, for example, at 9 pm Pacific Time or 9 pm Indian Standard Time, or 7 am in Suzhou and 7 am Pacific Time, which are common times for international virtual meetings.

Another advantage of the methods and systems of the present disclosure is increasing in-person interactions without compromising efficiency. In-Person interactions are a key to a healthy life and remote workplace environments have resulted in a disconnected work force resulting in issues, such as, depression, higher attrition rates, and/or drop in efficiency in a longer run. The methods and systems may help users improve their work life balance by providing recommendations for subgroups for meetings to help the meeting occur in person and/or during working hours while maintaining flexibility of virtual meetings as well.

The methods and systems may aid users in scheduling meetings by providing recommendations for in-person meeting locations for different subgroups of the meeting attendees. The methods and systems may divide the meeting attendees into subgroups based on their characteristics (e.g., geographical location, working hours, distance from relevant subgroups, and/or working groups) and/or the meeting context. The methods and systems identify a meeting location for each of the subgroups and a meeting time for each subgroup.

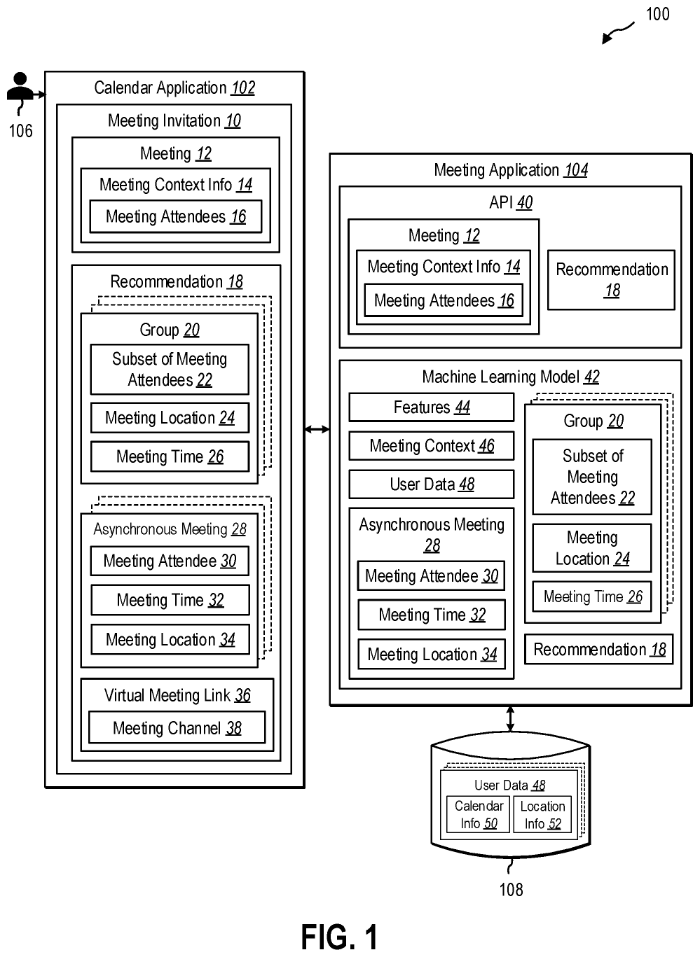

Referring now to FIG. 1, illustrated is an example environment 100 for providing recommendations 18 for scheduling meetings 12. The environment 100 includes a calendar application 102 that a user 106 accesses to schedule one or more meetings 12. The calendar application 102 may be on a device of the user 106. To schedule a meeting 12, the user 106 may open an electronic meeting invitation 10 on the calendar application 102. The calendar application 102 provides a user interface for the user 106 to use in scheduling the meeting 12.

The user 106 may provide meeting context information 14 for the meeting 12 in the meeting invitation 10. The meeting context information 14 includes the meeting attendees 16 (e.g., the individuals invited to the meeting 12 or the individuals required to join the meeting 12). The meeting context information 14 may also include a title of the meeting 12, text from the body of the meeting invitation 10 (e.g., a message or other information provided in a body of the meeting invitation 10), an amount of time scheduled for the meeting 12, and/or any attachments to the meeting invitation 10 (e.g., documents, images, and/or videos). The meeting context information 14 may be obtained from the information provided by the user 106 in the meeting invitation 10.

The calendar application 102 may communicate the meeting 12 and the meeting context information 14 to a meeting application 104 using an application programming interface (API) 40. In some implementations, in response to the meeting invitation 10 being opened, the calendar application 102 provides the meeting 12 and the meeting context information 14 to the meeting application 104 via the API 40.

In some implementations, the meeting application 104 may be implemented by a cloud service provider and the calendar application 102 communicates with the meeting application 104 via a network. The network may include one or multiple networks that use one or more communication platforms or technologies for transmitting data. For example, the network may include the internet or other data link that enables transport of electronic data between respective devices of the environment 100.

The meeting application 104 includes a machine learning model 42 that receives the meeting context information 14 with the meeting attendees 16 as input. The machine learning model 42 may also receive user data 48 associated with the meeting attendees 16. In some implementations, the machine learning model 42 accesses a datastore 108 with a database of user data 48 and accesses the user data 48 associated with the meeting attendees 16. In some implementations, users (e.g., individuals of an organization) may have to explicitly opt into data collection and/or the users can opt out of data collection.

The user data 48 may include calendar information 50 and/or location information 52 of the users. For example, the location information 52 includes an office location of the users and/or a residential address where the users work from home. The location information 52 may also include a current geographic location of the users. The location information 52 may also include office locations that the meeting attendee 16 frequently visits. For example, an employee may be assigned an office in one building that may be further away from a residential address for the employee, and the employee may frequently visit an office location closer to the employee's residential address instead of the assigned office. Another example includes a meeting attendee 16 frequently visiting an office building to meet with other team members.

The calendar information 50 may include previously scheduled meetings or appointments, blocked time slots, and/or available time slots for meetings. The calendar information 50 may also include the working hours of the meeting attendees 16.

The machine learning model 42 may process the meeting context information 14 and the user data 48 to determine one or more features 44 for the meeting attendees 16 and/or the meeting 12. One example of the features 44 is a number of meeting attendees for the meeting 12. The features 44 indicate a total number of meeting attendees 16 for the meeting 12 determined by analyzing the meeting attendees 16 invited to the meeting 12. Another example of the features 44 is an office location of the meeting attendees 16. Another example of the features 44 is a residential address of the meeting attendees 16. The office location or the residential address information may be determined by analyzing the location information 52 of the user data 48.

Another example of the features 44 is the business hours of the meeting attendees 16. The machine learning model 42 may identify the business hours of the meeting attendees based on a time zone of the office location of the meeting attendees 16. The machine learning model 42 may also learn the habits of the meeting attendees 16 by analyzing the calendar information 50 obtained in the user data 48 to determine patterns and/or trends in working hours for the meeting attendees 16 and determine the preferred business hours of the meeting attendees 16 or a preferred time of day to schedule meetings. For example, some of the meeting attendees 16 may prefer to start their workday early and have their workday end in the early afternoon, while others of the meeting attendees 16 may prefer to start their workday later and have their workday end late in the evening.

In addition, the machine learning model 42 may analyze the meeting context information 14 to infer the meeting context 46. The meeting context 46 may include a topic for the meeting 12, an agenda for the meeting 12, a purpose of the meeting 12, and/or content for the meeting 12. In some implementations, the machine learning model 42 is a natural language machine learning model and the machine learning model 42 applies natural language processing to the meeting context information 14 to obtain the meeting context 46. Examples of the machine learning model 42 include (Bidirectional Encoder Representations from Transformers) BERT models and/or Embeddings from Language Models (ELMO).

The machine learning model 42 may use the analysis of the different features 44 and/or the meeting context 46 to generate one or more recommendations 18 for the meeting 12. In some implementations, the recommendation 18 includes determining whether to conduct the meeting 12 in person, conduct a virtual meeting, or provide a hybrid meeting (e.g., an in-person option along with a virtual option). The recommendation 18 may be for a large group meeting where a single meeting location is booked for all of the meeting attendees 16 to attend the meeting 12. The recommendation 18 may also be for different groups 20 and providing different meeting locations 24 for each group 20 so that different subsets of the meeting attendees 22 may meet in person at the different meeting locations 24 for the meeting 12. The recommendation 18 may also be for a hybrid meeting with an in-person meeting option and a virtual option for those meeting attendees 16 that are unable to attend in person.

For example, the machine learning model 42 uses the features 44 of the number of meeting attendees 16 to determine whether to provide a recommendation 18 for an in-person meeting or a virtual meeting. If the number of meeting attendees 16 exceeds a threshold number, the machine learning model 42 provides a recommendation 18 for a virtual meeting with a virtual meeting link 36. If the number of meeting attendees 16 is equal to or below a threshold number, the recommendation 18 may be for an in-person meeting.

Another example includes the machine learning model 42 analyzing the meeting context 46 to determine whether to provide a recommendation 18 for an in-person meeting, a virtual meeting, or a hybrid meeting (e.g., an in-person option along with a virtual option) based on the meeting context 46. For example, if the meeting context 46 identifies the goal of the meeting 12 is brainstorming meeting, the machine learning model 42 may provide a recommendation 18 for an in-person meeting. Another example includes if the meeting context 46 identifies the object of the meeting 12 is informational, the machine learning model 42 may provide a recommendation 18 for a virtual meeting.

In some implementations, the machine learning model 42 determines one or more groups 20 for the meeting attendees 16 based on the analysis of the different features 44 for the meeting attendees 16. The machine learning model 42 places a subset of the meeting attendees 22 into each group 20 based on the analysis of the features 44. For example, the machine learning model 42 analyzes the office locations of the meeting attendees 16 and places the meeting attendees 16 into the different groups 20 based on the office locations of the meeting attendees 16. If the meeting attendees 16 are located on the same floor of a building, the meeting attendees 16 may easily meetup in a meeting room on the same floor. As such, each group 20 may include a subset of meeting attendees 22 in a same office location or nearby office location.

Another example includes the machine learning model 42 analyzing the business hours of the meeting attendees 16 and placing the meeting attendees 16 into the different groups 20 based on the business hours of the meeting attendees 16. For example, meeting attendees 16 in a same time zone may be placed into a group 20 together and meeting attendees with a preference for meetings in the afternoon may be placed into a group 20 together. As such, each group 20 may include a subset of meeting attendees 22 attending the meeting 12 during business hours of the meeting attendees or attending the meeting 12 during a preferred time for meetings.

Another example includes the machine learning model 42 analyzing a residential address for the meeting attendees 16 and placing the meeting attendees 16 into different groups 20 based on a probability that the meeting attendees 16 may travel to a meeting location for the meeting 12. For example, if the weather for the meeting attendees 16 is poor on the day the meeting 12 is scheduled, the meeting attendees 16 may have a higher probability from working at home instead of commuting to meet in-person for the meeting 12. Another example includes if the traffic conditions are poor during the meeting time, the meeting attendees 16 may have a higher probability of working at home instead of commuting to meet in-person for the meeting 12. Another example includes if the meeting attendee 16 is in a different geographic location, the meeting attendee 16 may have a lower probability of traveling to meet in-person for the meeting 12. Another example includes determining a distance from a residential address to an office location. If the residential address of a meeting attendee 16 is located far away from the office, the meeting attendee 16 may have a lower probability of traveling to meet in-person for the meeting 12, and if the residential address is located near the office, the meeting attendees 16 may have a higher probability of traveling to meet in-person for the meeting 12. As such, the different groups 20 may include a subset of meeting attendees 22 that have a higher probability of meeting in-person for the meeting 12 and a subset of meeting attendees 22 that have a higher probability of meeting virtually for the meeting 12.

Another example includes the machine learning model 42 analyzing the meeting context 46 of the meeting and placing the meeting attendees 16 into different groups 20 based on the meeting context 46. For example, if the meeting context 46 indicates that the purpose of the meeting 12 is for different teams to present a topic, the machine learning model 42 may place the meeting attendees 16 into different groups 20 based on team affiliations.

In addition, the machine learning model 42 may place the meeting attendees 16 into the different groups 20 based on a combination of different features 44 and/or the meeting context 46. For example, the machine learning model 42 may create the groups 20 based on office locations of the meeting attendees 16 and the business hours of the meeting attendees 16. Another example includes the machine learning model 42 creating the groups 20 based on the meeting context 46 of the meeting 12 and the office locations of the meeting attendees 16. As such, the machine learning model 42 may divide the meeting attendees 16 into subgroups (e.g., different groups 20) based on the analysis of the features 44 and/or the meeting context 46.

The recommendation 18 may identify a meeting location 24 for each group 20 based on the analysis of the features 44. The meeting locations 24 may include physical locations, such as, an office, a room (e.g., a conference room, meeting room), a restaurant, a coffee shop, and/or an outdoor location. As such, each group 20 may include a different meeting location 24. In some implementations, the meeting location 24 may include a virtual meeting location. As such, the recommendation 18 may provide a hybrid meeting with both in-person and virtual options for different groups 20 created for the meeting 12.

The recommendation 18 may also identify a meeting time 26 for each group 20 based on the analysis of the features 44. The meeting time 26 may be at the same time. As such, each group 20 may meet at different meeting locations 24 (e.g., different physical locations) at the same meeting time 26 for the meeting 12. For example, a subset of meeting attendees 16 for a first group may be located in the United States and a subset of meeting attendees 16 for a second group may be located in Europe, the meeting time 26 for the meeting 12 may be selected during the working hours for both groups.

In some implementations, the meeting time 26 may be at separate times. As such, the different groups 20 may have different meeting times 26 for the meeting 12. For example, if the subset of meeting attendees 22 for a first group 20 are located in India and the subset of meeting attendees 22 for a second group 20 are located in the United States, the meeting times 26 for the meeting 12 may be at separate times during the working hours of each group 20.

In some implementations, the machine learning model 42 analyzes the meeting context 46 to determine whether the meeting 12 may be conducted at separate meeting times 26. The machine learning model 42 may identify a suitable meeting time 26 for each group 20 and provide a recommendation 18 with a meeting location 24 and a meeting time 26 for each group 20.

One example use case includes the meeting context 46 indicating that the purpose of the meeting 12 is to discuss a document attached to the meeting invitation 10. The metadata of the document indicates that the document has different subsections where different meeting attendees 16 are responsible for the different subsections. The machine learning model 42 may use the meeting context 46 and the meeting context information 14 (e.g., the document metadata) to determine the groups 20 based on the different subsections of the document. The machine learning model 42 may place a subset of the meeting attendees 22 into each group 20 based on which subsections of the documents the meeting attendees 16 are working on. The machine learning model 42 may further determine that each group 20 may meet at separate meeting times 26 to discuss the portion of the document that the group 20 is responsible for. As such, different groups 20 may have different meeting times 26 for the meeting 12.

In some implementations, the machine learning model 42 analyzes the meeting context 46 to determine a recommended time duration for the meeting 12. For example, a 50 page document may not be effectively discussed in a 30 minute meeting.

The recommendation 18 may also include providing a virtual meeting link 36 to provide a connection so that the different groups 20 (e.g., the subset of meeting attendees 22 at the different meeting locations 24) may communicate with each other. By connecting the different meeting locations 24 together with a virtual meeting link 36, the subset of meeting attendees 22 for the different groups 20 may meet in-person together and still communicate with the other meeting attendees 16 for the meeting 12 using the virtual meeting link 36. Moreover, any meeting attendees 16 that are unable to attend a group 20 in person may use the virtual meeting link 36 to connect to the meeting 12.

In addition, the virtual meeting link 36 includes a meeting channel 38 where the meeting attendees 16 may share notes, ideas, comments, messages, and/or edit to documents during the meeting 12 within the meeting channel 38. For example, the meeting attendees 16 may upload electronic copies of notes to the meeting channel 38. Another example includes the meeting attendees 16 may share URL links to the meeting channel 38. Another example includes the meeting attendees 16 may share instant messages or electronic chats in the meeting channel 38. Another example includes the meeting attendees 16 may upload documents with edits or electronic comments added to the meeting channel 38.

In some implementations, if the meeting 12 includes different groups 20 meeting at separate meeting times 26, the subset of meeting attendees 22 may access the meeting channel 38 to see other the information shared by other meeting attendees 16 and/or to provide the information captured from the group 20 meeting to the meeting channel 38. As such, the meeting channel 38 provide a single location to capture the different notes, ideas, comments, messages, and/or edits to documents in a single location for the different groups 20 for the meeting 12.

The machine learning model 42 may identify when a meeting 12 has both global and local characteristics (e.g., the meeting attendees 16 are located in different geographical locations with clusters of individuals in a local area) and provides a recommendation 18 to provide local in-person meeting options for different subgroups of the meeting attendees 16 (e.g., the different groups 20) while connecting the different subgroups of meeting attendees 16 together using the virtual meeting link 36 and/or the meeting channel 38.

In some implementations, the machine learning model 42 uses the meeting context 46 to identify that the meeting attendees 16 may benefit from asynchronous meetings 28 prior to the meeting 12 occurring. For example, the machine learning model 42 analyzes the meeting context information 14 to determine the meeting context 46. The meeting context 46 may include a topic for the meeting 12, an agenda for the meeting 12, and/or a purpose of the meeting 12. In some implementations, the meeting context 46 may also include a number of meeting attendees 16 that have reviewed a document attachment, a meeting attendee 16 who needs to review the document, a length of the document, an agenda of the document, or a topic of the document.

The asynchronous meetings 28 may be beneficial for meeting context 46 that indicates interactions among the meeting attendees 16 may not be required. Examples where interactions may not be required include an individual review of documents (e.g., specification reviews, design document reviews), bug bashes, and/or filling connects. The asynchronous meetings 28 may be beneficial if the meeting context 46 indicates that the goal of the meeting 12 is to review a 50 page document. The asynchronous meetings 28 may not be beneficial if the meeting context 46 indicates that the document length of the attached document is 1 page.

The recommendations 18 may include a meeting location 34 and a meeting time 32 for the asynchronous meetings 28 to occur prior to the meeting 12. As such, each meeting attendee 16 may have an asynchronous meeting 28 scheduled with a meeting time 32 and a meeting location 34 to individually perform an action needed for the meeting 12 (e.g., document review) prior to the meeting 12 occurring.

One example use case includes if the meeting context 46 identifies that the meeting 12 is for discussing a design document, the machine learning model 42 may provide a recommendation 18 to schedule the asynchronous meetings 28 for the meeting attendees 16 at a meeting time 32 and/or a meeting location 34 so that each meeting attendee 16 may independently review the design document prior to the meeting 12 occurring to discuss the design document. Each asynchronous meeting 28 may be scheduled for an individual meeting attendee 16.

In some implementations, the machine learning model 42 may analyze the meeting context information 14 to determine which meeting attendees 30 (e.g., a subset of the meeting attendees 16) may need the asynchronous meetings 28. For example, the meeting context information 14 may include document metadata, such as contributor metadata, relevant reviewer lists, and/or a percentage of the document already reviewed by individuals. The machine learning model 42 may use the meeting context information 14 to determine a number of meeting attendees 16 that have already reviewed the document. The machine learning model 42 may provide a recommendation 18 to schedule the asynchronous meetings 28 for the meeting attendees 30 (e.g., a subset of the meeting attendees 16) that have not reviewed the document. If a certain percentage of the meeting attendees 16 have already reviewed the document (e.g., the percentage of reviewers is above a threshold level), the machine learning model 42 may provide a recommendation 18 to schedule the meeting 12 without the asynchronous meetings 28 prior to the meeting 12.

Another example includes the document metadata may identify one or more meeting attendees 16 that are required to review the document (e.g., individuals that are required to sign off on the document). The machine learning model 42 may provide a recommendation 18 to schedule the asynchronous meetings 28 for the meeting attendees 30 (e.g., a subset of the meeting attendees 16) that are required to review the document).

The recommendations 18 are provided to the calendar application 102 and presented to the user 106 within the meeting invitation 10 to aid the user 106 in scheduling the meeting 12. In some implementations, the recommendations 18 automatically create the different groups 20 with the subset of meeting attendees 22 with the recommended meeting locations 24 and the meeting times 26 so that the user 106 may create the meeting 12 with the subgroups with a single click (e.g., sending the meeting invitation 10 to the meeting attendees 16). As such, the recommendations 18 may aid the user 106 in easily scheduling the meeting 12 while helping to improve the work life balance of the meeting attendees 16 by taking into account working preferences (e.g., working hours, working from home, and/or meeting in person) when scheduling the meetings 12. In some implementations, the recommendations 18 create the different groups 20 with the subset of meeting attendees 22 with the recommended meeting locations 24 and the meeting times 26 in response to the user 106 selecting an icon or providing another indication to create the different groups 20.

In some implementations, one or more computing devices are used to perform the processing of environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the calendar application 102, the meeting application 104, and/or the datastore 108 are implemented wholly on the same computing device. Another example includes one or more subcomponents of the calendar application 102, the meeting application 104 (e.g., the machine learning model 42), and/or the datastore 108 implemented across multiple computing devices. Moreover, in some implementations, the calendar application 102, the meeting application 104, and/or the datastore 108 are implemented or processed on different server devices of the same or different cloud computing networks. Moreover, in some implementations, the features and functionalities are implemented or processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

As such, the environment 100 may aid the users 106 in scheduling meetings 12 by providing recommendations 18 for meeting locations for different subgroups of the meeting attendees 16. The methods and systems may automatically place the meeting attendees 16 into the different subgroups based on the features 44 of the meeting attendees 16 and/or the meeting context 46.

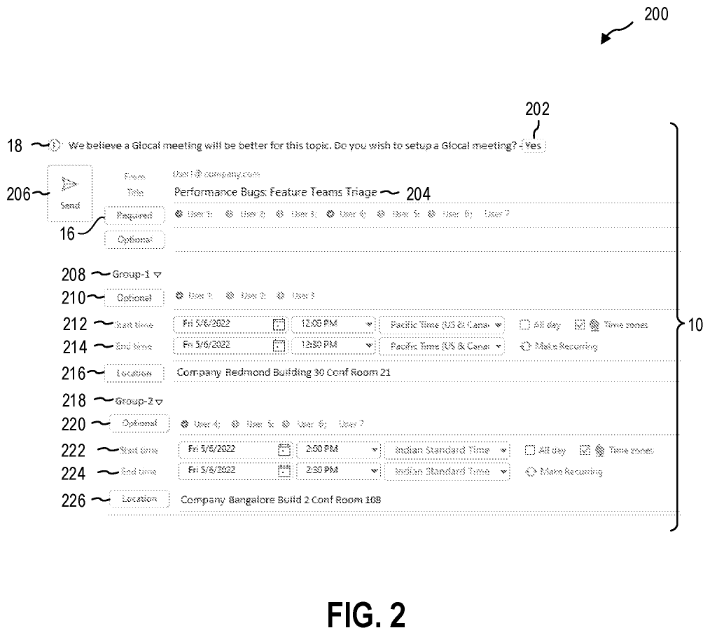

Referring now to FIG. 2, illustrated is an example graphical user interface 200 of a meeting invitation 10 for a meeting 12 (FIG. 1) created by the user 106 (FIG. 1). The meeting invitation 10 includes a meeting title 204 and the meeting attendees 16. The meeting invitation 10 also includes a recommendation 18 that a meeting with different groups 20 (FIG. 1) of meeting attendees 16. The recommendation 18 may be generated by the meeting application 104 in response to the meeting invitation 10 being opened by the user 106 and the meeting context information 14 (FIG. 1) being provided by the user 106 (e.g., the meeting title 204, the meeting attendees 16).

The meeting invitation 10 may also include an icon 202 that the user 106 may select to automatically set up a glocal meeting in response to the recommendation 18. If the user 106 selects the icon 202 to setup the groups 20 (e.g., Group 1 208 and Group 2 218) for the meeting 12, the recommendation 18 may further provide the subsets of the meeting attendees 22 assigned to the different groups 20 determined by the machine learning model 42 (FIG. 1). For example, Group 1 208 has a first subset of meeting attendees 210 and Group 2 218 has a second subset of meeting attendees 220.

The recommendation 18 may also include the meeting times 26 (FIG. 1) for the different groups 20 determined by the machine learning model 42. The Group 1 208 has a start time 212 of 12:00 pm Pacific Time and an end time 214 of 12:30 pm Pacific Time for the meeting 12. The Group 2 218 has a start time 222 of 2:00 pm Indian Standard Time and an end time 224 of 2:30 pm Indian Standard Time for the meeting 12. The meeting times 26 are selected for the two groups (e.g., the Group 1 208 and the Group 2 218) based on calendar availability of the subset of meeting attendees 16 for each group (e.g., the first subset of meeting attendees 210 and the second subset of meeting attendees 220). Moreover, the two groups are located in different time zones, as such, the meeting times 26 are selected based on the time zone of the two groups. In the illustrated example, the meeting 12 is not scheduled to occur at the same time.

The recommendation 18 may also include the meeting locations 24 (FIG. 1) determined by the machine learning model 42. The Group 1 208 has a first location 216 at a building in Redmond, Washington and the Group 2 218 has a second location 226 at a building in Bangalore, India. As such, instead of conducting a virtual meeting between the two groups for the meeting 12 at the same meeting time, the subset of meeting attendees 16 for each group (e.g., the first subset of meeting attendees 210 and the second subset of meeting attendees 220) may meet in person locally for the meeting 12 at a meeting time 26 convenient for each group 20 (e.g., the Group 1 208 and the Group 2 218).

In some implementations, a meeting channel 38 (FIG. 1) is also provided so that the two different groups (e.g., the Group 1 208 and the Group 2 218) may share notes, ideas, comments, messages, and/or edit to documents within the meeting channel 38. In some implementations, the meeting channel 38 is provided in a virtual meeting link 36.

The user 106 may click an icon 206 to send the meeting invitation 10 to the meeting attendees 16 for the meeting 12. As such, the user 106 may use the graphical user interface 200 to automatically schedule the meeting 12 in different geographic locations at a location and time that is convenient for the different meeting attendees to meet in person for the meeting 12.

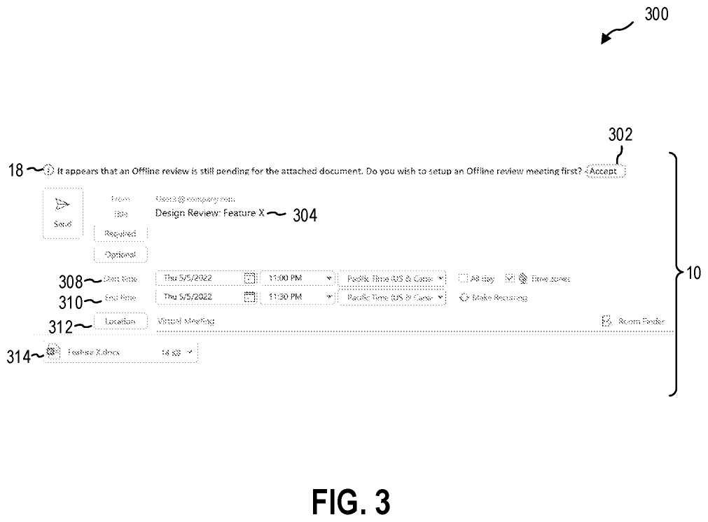

Referring now to FIG. 3, illustrated is an example graphical user interface 300 of a meeting invitation 10 for a meeting 12 (FIG. 1) created by the user 106 (FIG. 1). The meeting invitation 10 includes a meeting title 304. The meeting invitation 10 also includes a recommendation 18 that indicates that an asynchronous meeting 28 (FIG. 1) may be beneficial for an offline review of the document attachment 314 to occur prior to scheduling the meeting 12. The recommendation 18 may be generated by the meeting application 104 in response to the meeting invitation 10 being opened by the user 106 and the meeting context information 14 (FIG. 1) being provided by the user 106 (e.g., the meeting title 304, the document attachment 314, the meeting start time 308, the meeting end time 310, and the meeting location 312).

The meeting invitation 10 may also include an icon 302 that the user 106 may select to automatically set up the asynchronous meeting 28 in response to the recommendation 18. If the user 106 selects to setup the asynchronous meeting 28, the recommendation 18 may further provide different meeting times 32 (FIG. 1) and/or different meeting locations 34 (FIG. 1) for the asynchronous meetings 28 prior to the meeting start time 308 for the meeting 12.

In some implementations, the machine learning model 42 may analyze the document metadata of the document attachment 314 to identify a number of meeting attendees 16 (FIG. 1) that have reviewed the document or have provided comments for the document. If the meeting attendee 16 has already reviewed the document, the asynchronous meeting 28 may not be scheduled. If the meeting attendee 16 has not reviewed the document, the asynchronous meeting 28 may be scheduled for the meeting attendee 16 prior to the meeting 12 to discuss the document (e.g., prior to the start time 308).

As such, the graphical user interface 300 may aid the user 106 in automatically identifying when one or more asynchronous meetings 28 may be beneficial prior to a start of a meeting 12 and automatically identifying a meeting location 34 and/or a meeting time 32 for the meeting asynchronous meetings 28 to occur prior to the start time 308 of the meeting 12.

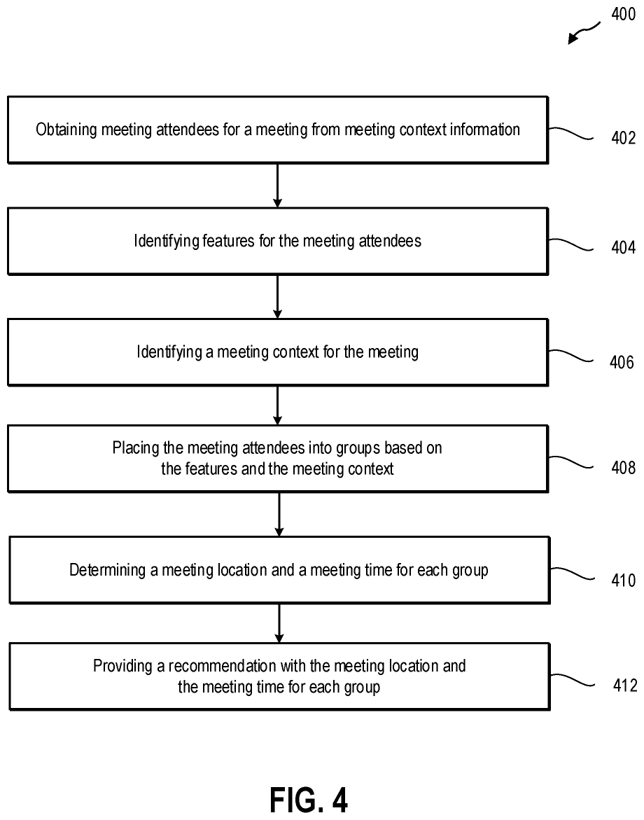

Referring now to FIG. 4, illustrated is an example method 400 for providing a recommendation 18 (FIG. 1) for a meeting 12 (FIG. 1). The actions of the method 400 are discussed below with reference to the architecture of FIG. 1.

At 402, the method 400 includes obtaining meeting attendees for a meeting from meeting context information 14. The meeting application 104 may obtain the meeting context information 14 from a calendar application 102 via the API 40. In some implementations, the meeting context information 14 is automatically obtained in response to a meeting invitation 10 being opened in the calendar application 102. For example, the user 106 may provide the meeting context information 14 for the meeting 12 in the meeting invitation 10. In some implementations, users (e.g., individuals of an organization) may have to explicitly opt into data collection and/or the users can opt out of data collection.

The meeting context information 14 includes the meeting attendees 16 (e.g., the individuals invited to the meeting 12 or the individuals required to join the meeting 12). The meeting context information 14 may also include a title of the meeting, text from the body of the meeting invitation (e.g., a message or other information provided in a body of the meeting invitation), an amount of time scheduled for the meeting 12, and/or any attachments to the meeting invitation (e.g., documents, images, and/or videos).

At 404, the method 400 includes identifying features for the meeting attendees. The machine learning model 42 identifies the features 44 of the meeting attendees 16 based on an analysis of the meeting context information 14 and/or the user data 48, and/or a meeting context 46. The machine learning model receives the meeting context information 14 and the user data 48 as input and determines the features 44 of the meeting attendees 16 based on the analysis. The user data 48 may include calendar information 50 and/or location information 52 of the users. In some implementations, the machine learning model 42 analyzes trends and/or patterns in the user data 48 to learn user behaviors or preferences in determining the features 44.

In some implementations, the features 44 of the meeting attendees 16 identify a geographic location of the meeting attendees 16 (e.g., a residential address, an office location). In some implementations, the features 44 of the meeting attendees 16 identify a frequently visited office location. In some implementations, the features 44 of the meeting attendees 16 identify meeting preferences of the meeting attendees 16 (e.g., prefer meeting to occur in 30 minute segments or prefer meetings to occur early in the morning). In some implementations, the features 44 of the meeting attendees 16 identify the business hours of the meeting attendees 16.

At 406, the method 400 includes identifying a meeting context for the meeting. In some implementations, the machine learning model 42 processes a meeting title, a meeting body, and attachment content from the meeting context information 14 to determine the meeting context 46. The meeting context 46 may include a topic of the meeting 12, a goal of the meeting 12, an agenda of the meeting 12, an objective of the meeting 12, a purpose of the meeting 12, and/or content for the meeting 12. In some implementations, the machine learning model 42 is a natural language machine learning model and the machine learning model 42 applies natural language processing to the meeting context information 14 to obtain the meeting context 46.

At 408, the method 400 includes placing the meeting attendees into groups based on the features and the meeting context. Each group 20 has a subset of meeting attendees 22. In some implementations, the machine learning model 42 determines one or more groups 20 for the meeting attendees 16 based on the analysis of the different features 44 for the meeting attendees 16 and/or the meeting context 46 and places the subset of the meeting attendees 22 into each group 20 based on the analysis of the features 44 and/or the meeting context 46.

In addition, the machine learning model 42 may place the meeting attendees 16 into the different groups 20 based on a combination of different features 44 and/or the meeting context 46. One example includes the machine learning model 42 creating the groups 20 based on the meeting context 46 of the meeting 12 and the office locations of the meeting attendees 16. As such, the machine learning model 42 may divide the meeting attendees 16 into subgroups (e.g., different groups 20) based on the analysis of the features 44 and/or the meeting context 46. In some implementations, the meeting context 46 is used to provide a recommendation 18 for a hybrid meeting with a physical meeting location 24 for each group 20 and a virtual meeting link 36 for the meeting 12 for the meeting attendees 16 unable to meet in person for the meeting 12.

At 410, the method 400 includes determining a meeting location and a meeting time for each group. The machine learning model 42 identifies a meeting location 24 for each group 20 based on the analysis of the features 44 and/or the meeting context 46. In some implementations, the meeting location 24 is a physical location for the meeting 12 and each group 20 has a different physical location for the meeting 12. The physical location 24 may include an office, a room, a restaurant, a coffee shop, and/or an outdoor location.

The machine learning model 42 also identifies a meeting time 26 for each group 20 based on the analysis of the features 44 and/or the meeting context 46. In some implementations, the meeting time 26 is based on a time zone for each group 20. In some implementations, the meeting time 26 is based on a preferred meeting time or work hours of the subset of meeting attendees 22 for each group 20. In some implementations, the meeting time 26 is scheduled for each group 20 at the same time. In some implementations, the meeting time 26 is scheduled at separate times for the different groups 20.

In some implementations, the machine learning model 42 analyzes the meeting context 46 to determine a recommended time duration for the meeting 12. For example, a 50 page document may not be effectively discussed in a 30 minute meeting. In some implementations, the machine learning model 42 analyzes the meeting context 46 to determine whether the meeting 12 may be conducted at separate meeting times 26.

At 412, the method 400 includes providing a recommendation with the meeting location and the meeting time for each group. The machine learning model 42 may identify a suitable meeting time 26 for each group 20 and provide a recommendation 18 with a meeting location 24 and a meeting time 26 for each group 20. The meeting application 104 may provide the recommendation 18 to the calendar application 102 via the API 40. The recommendation 18 may identify a meeting location 24 for each group 20 identified based on the analysis of the features 44 and/or the meeting context 46. The recommendation 18 may also identify a meeting time 26 for each group 20 based on the analysis of the features 44 and/or the meeting context 46.

In some implementations, the recommendation 18 includes a single meeting channel 38 that captures electronic notes, electronic comments, electronic messages, or updates to documents shared from each group 20. The meeting channel 38 may be provided in a virtual meeting link 36 that provides a connection for the different groups 20 to communicate together. The virtual meeting link 36 may also provide a virtual meeting option for any meeting attendees 16 unable to attend the meeting location 24 selected for each group 20. By connecting the different meeting locations 24 together with a virtual meeting link 36, the subset of meeting attendees 22 for the different groups 20 may meet in-person together and still communicate with the other meeting attendees 16 for the meeting 12 using the virtual meeting link 36. Moreover, any meeting attendees 16 that are unable to attend a group 20 in person may use the virtual meeting link 36 to connect to the meeting 12.

In some implementations, the machine learning model 42 identifies when a meeting 12 has both global and local characteristics (e.g., the meeting attendees 16 are located in different geographical locations with clusters of individuals in a local area) and provides a recommendation 18 to provide local in-person meeting options for different subgroups of the meeting attendees 16 (e.g., the different groups 20) while connecting the different subgroups of meeting attendees 16 together using the virtual meeting link 36 and/or the meeting channel 38.

The recommendation 18 is presented to the user 106 within the meeting invitation 10 to aid the user 106 in scheduling the meeting 12. In some implementations, the recommendations 18 automatically creates the different groups 20 with the subset of meeting attendees 22 with the recommended meeting locations 24 and the meeting times 26 so that the user 106 may create the meeting 12 with the subgroups with a single click (e.g., sending the meeting invitation 10). In some implementations, the recommendations 18 create the different groups 20 with the subset of meeting attendees 22 with the recommended meeting locations 24 and the meeting times 26 in response to the user 106 selecting an icon or providing another indication to create the different groups 20.

The method 400 may be used to aid the user 106 in easily scheduling the meeting 12 while helping to improve the work life balance of the meeting attendees 16 by taking into account working preferences (e.g., working hours, working from home, and/or meeting in person) when scheduling the meetings 12.

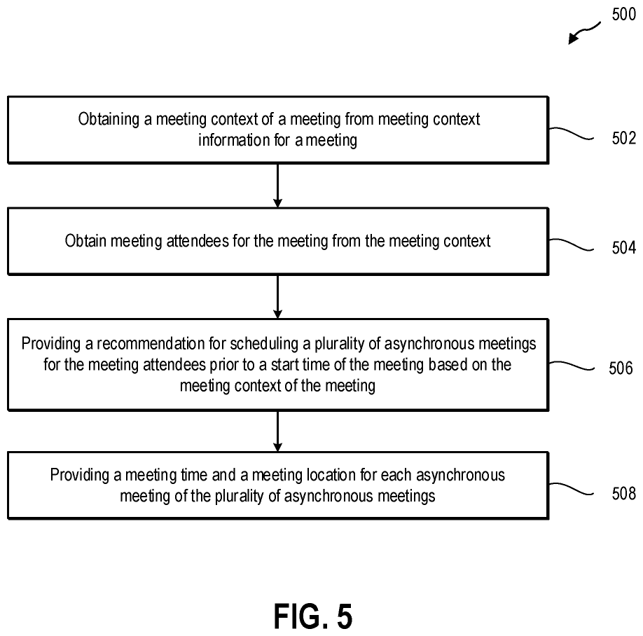

Referring now to FIG. 5, illustrated is an example method 500 for providing a recommendation 18 (FIG. 1) for a meeting 12 (FIG. 1). The actions of the method 500 are discussed below with reference to the architecture of FIG. 1.

At 502, the method 500 includes obtaining a meeting context of a meeting from meeting context information for the meeting. The meeting application 104 may obtain the meeting context information 14 from a calendar application 102 via the API 40. In some implementations, the meeting context information 14 is automatically obtained in response to a meeting invitation 10 being opened in the calendar application 102. For example, the user 106 may provide the meeting context information 14 for the meeting 12 in the meeting invitation 10. In some implementations, users (e.g., individuals of an organization) may have to explicitly opt into data collection and/or the users can opt out of data collection.

The meeting context information 14 may also include a title of the meeting, text from the body of the meeting invitation (e.g., a message or other information provided in a body of the meeting invitation), an amount of time scheduled for the meeting 12, and/or any attachments to the meeting invitation (e.g., documents, images, and/or videos). The meeting context 46 may include goals, purposes, needs, objectives, and/or content of the meeting 12. In addition, the meeting context 46 may include a number of meeting attendees that have reviewed a document attachment, a meeting attendee who needs to review the document, a length of the document, an agenda of the document, or a topic of the document.

At 504, the method 500 includes obtaining meeting attendees for the meeting from the meeting context. The meeting context information 14 may also include the meeting attendees 16 (e.g., the individuals invited to the meeting 12 or the individuals required to join the meeting 12). The machine learning model 42 may obtain the meeting attendees 16 from the meeting context information 14.

At 506, the method 500 includes providing a recommendation for scheduling a plurality of asynchronous meetings for the meeting attendees prior to a start time of the meeting based on the meeting context of the meeting. In some implementations, the machine learning model 42 may analyze the meeting context information 14 and determine that the asynchronous meetings 28 may be scheduled for one or more meeting attendees 16 prior to a start time of the meeting 12.

For example, the meeting context information 14 may include document metadata, such as contributor metadata, relevant reviewer lists, and/or a percentage of the document already reviewed by individuals. The machine learning model 42 may use the meeting context information 14 to determine a number of meeting attendees 16 that have already reviewed the document. The machine learning model 42 may provide a recommendation 18 to schedule the asynchronous meetings 28 for the meeting attendees 30 (e.g., a subset of the meeting attendees 16) that have not reviewed the document. If a certain percentage of the meeting attendees 16 have already reviewed the document (e.g., the percentage of reviewers is above a threshold level), the machine learning model 42 may provide a recommendation 18 to schedule the meeting 12 without the asynchronous meetings 28 prior to the meeting 12.

At 508, the method 500 includes providing a meeting time and a meeting location for each asynchronous meeting of the plurality of asynchronous meetings. Each asynchronous meeting 28 includes a meeting time 32 prior to the start of the meeting 12 and a meeting location 34 for the asynchronous meeting 28. In some implementations, each asynchronous meeting 28 is scheduled for an individual meeting attendee 30. The recommendations 18 may be provided to the calendar application 102 via the API 40 and presented to the user 106.

In some implementations, the recommendations 18 automatically creates the different asynchronous meetings 28 with the recommended meeting locations 34 and the meeting times 32 so that the user 106 may create the meeting 12 with the asynchronous meetings 28 already scheduled for the different meeting attendees for the meeting 12. In some implementations, the recommendations 18 create the different asynchronous meetings 28 with the recommended meeting locations 34 and the meeting times 32 in response to the user 106 selecting an icon or providing another indication to create the different asynchronous meetings 28.

The method 500 may be used to aid the user 106 in automatically identifying when asynchronous meetings 28 for a meeting attendee 16 to perform an action prior to a meeting 12 occurring (e.g., a start time of a meeting 12) may be beneficial based on a meeting context 46 of the meeting 12. In addition, the method 500 may be used to aid the user 106 in automatically scheduling the asynchronous meetings 28 prior to the meeting 12 starting.

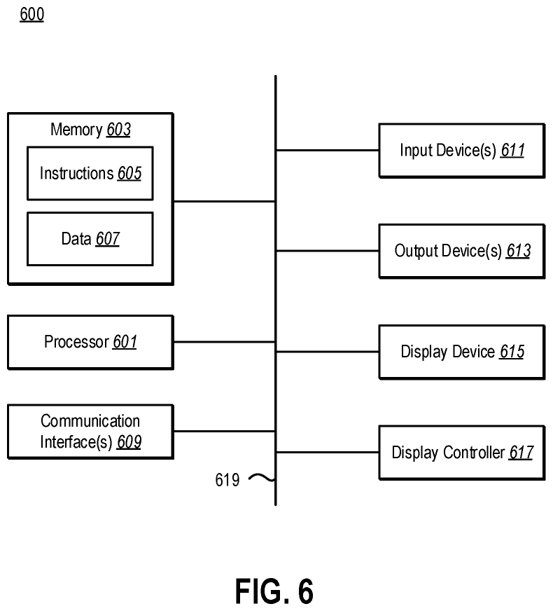

FIG. 6 illustrates components that may be included within a computer system 600. One or more computer systems 600 may be used to implement the various methods, devices, components, and/or systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth© wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
obtaining meeting attendees for a meeting from meeting context information;
identifying features for the meeting attendees;
identifying a meeting context for the meeting;
placing the meeting attendees into groups based on the features and the meeting context, wherein each group has a subset of the meeting attendees;
determining a meeting location and a meeting time for each group; and
providing a recommendation with the meeting location and the meeting time for each group.

2. The method of claim 1, wherein the meeting location is a physical location for the meeting and each group has a different physical locations for the meeting.

3. The method of claim 2, wherein the physical location includes one or more of an office, a room, a restaurant, a coffee shop, or an outdoor location.

4. The method of claim 1, wherein the meeting time is based on a time zone for each group.

5. The method of claim 1, wherein the meeting time is based on a preferred meeting time of the subset of the meeting attendees for each group or working hours of the subset of the meeting attendees for each group.

6. The method of claim 1, wherein the meeting time is scheduled for each group at a same time.

7. The method of claim 1, wherein the meeting time is scheduled at different times for different groups.

8. The method of claim 1, further comprising:
providing a single meeting channel that captures electronic notes, electronic comments, electronic messages, or updates to documents shared from each group.

9. The method of claim 8, wherein the single meeting channel is provided in a virtual meeting link that provides a connection for the groups to communicate together.

10. The method of claim 9, wherein the virtual meeting link provides a virtual meeting option for any meeting attendees unable to attend the meeting location selected for each group.

11. The method of claim 1, further comprising:
using the meeting context to recommend a hybrid meeting with a physical meeting location for each group and a virtual meeting link for the meeting attendees unable to attend the meeting location for the meeting.

12. The method of claim 1, wherein a machine learning model processes a meeting title, a meeting body, and attachment content from the meeting context information to determine the meeting context.

13. The method of claim 1, wherein the meeting context includes one or more of a topic of the meeting, a goal of the meeting, an agenda of the meeting, an objective of the meeting, or a purpose of the meeting.

14. The method of claim 1, wherein the recommendation is used to automatically schedule the meeting for the groups for the meeting location and the meeting time for each group.

15. The method of claim 1, wherein the features of the meeting attendees identify a geographic location of the meeting attendees.

16. The method of claim 1, wherein the features of the meeting attendees identify meeting preferences of the meeting attendees.

17. A method, comprising:
obtaining a meeting context of a meeting from meeting context information for the meeting;
obtaining meeting attendees for the meeting from the meeting context;
providing a recommendation for scheduling a plurality of asynchronous meetings for the meeting attendees prior to a start time of the meeting based on the meeting context of the meeting; and
providing a meeting time and a meeting location for each asynchronous meeting of the plurality of asynchronous meetings, wherein each asynchronous meeting is scheduled for an individual meeting attendee.

18. The method of claim 17, wherein the meeting context information includes one or more of a title of the meeting, text from a body of a meeting invitation, content of attachments to the meeting invitation, or metadata of attachments to the meeting invitation.

19. The method of claim 18, wherein the meeting context includes a number of meeting attendees that have reviewed a document attachment, a meeting attendee who needs to review the document, a length of the document, an agenda of the document, or a topic of the document.

20. The method of claim 19, wherein the plurality of asynchronous meetings are scheduled for the meeting attendees that need to review the document and the plurality of asynchronous meetings are not scheduled for the meeting attendees that have reviewed the document.
